(19) United States
(12) Patent Application Publication
(10) Pub. No.: US 2022/0254216 A1
(43) Pub. Date: Aug. 11, 2022

(54) VENDING MACHINE WITH CHARACTER-BASED USER INTERFACE, CHARACTER-BASED USER INTERFACE AND USES THEREOF

(71) Applicant: BMC Universal Technologies Inc., Newmarket (CA)

(72) Inventors: Bernie SCHWARZLI, Newmarket (CA); Robert SCHWARZLI, Newmarket (CA); Nicole HILL, Newmarket (CA)

(21) Appl. No.: 17/616,517

(22) PCT Filed: Jun. 5, 2020
(86) PCT No.: PCT/CA2020/050785

§ 371 Date: Dec. 3, 2021

Related U.S. Application Data
(60) Provisional application No. 62/857,377, filed on Jun. 5, 2019.

(51) Int. Cl. G07F 9/02; G06Q 20/18

(52) U.S. Cl. CPC G07F 9/02; G06Q 20/18

(57) ABSTRACT

A vending machine includes a secure housing; at least one dispensing element within the secure housing; and a character-based user interface associated with the secure housing, the character-based user interface including: an output system for presenting at least one stored video and/or audio sequence featuring a character; and an input system for receiving at least information provided by a person, the input system coordinated by the vending machine with the output system to receive at least some of the information in response to the presenting by the output system of a respective at least one video and/or audio sequence as a prompt for the person to provide the information.

### CROSS-REFERENCE TO RELATED APPLICATION

This application claims priority to U.S. Provisional Patent Application Ser. No. 62/857,377 filed on Jun. 5, 2019, the contents of which are incorporated herein by reference.

### FIELD OF THE INVENTION

The following relates generally to vending systems, and more particularly to user interfaces for vending systems.

### BACKGROUND OF THE INVENTION

United States Patent Application Publication No. 2014/0303774 to Schwarzli et al., the contents of which are incorporated by reference herein, discloses a vending machine having a secure housing containing a plurality of vender modules for dispensing a predetermined amount of merchandise into a container. A control panel receives a user selection of products from at least one selected vender module, loads a container onto a shuttle, drives the shuttle into dispensing communication with each selected vender module, and drives each selected vender module through at least one dispensing cycle to dispense the user selection of product. A sealing mechanism seals the container, and a dispensing mechanisms dispenses the container to a user-accessible portion of the vending machine.

As described in the '774 application, a purchaser who desires to purchase product selects the vender module (for example by number, product name, image or otherwise), as prompted by the display of the control panel interface of the control panel (a touch display device), by touching the appropriate region of the control panel interface. The purchaser can select the same vender module multiple times to purchase a plurality of metered dispensing amounts of the same type of product, and/or other vender modules containing other products sought to be purchased as part of the product mix. When the purchaser is finished selecting (indicated for example by the purchaser touching a particular region of the control panel interface displaying an ‘OK’ key or another end-of-sequence indicator), the control panel interface displays the amount of money required to pay for the selected product. The user inserts the required amount of coinage into a coin slot, or a bill of a sufficient denomination into the bill accepter slot, or a card such as a credit card, debit card or gift card into the card reader slot, in order to make payment. When the correct amount of money for the selected amount of bulk product has been inserted (or the credit card or debit card payment has been made via card acceptor and authorized), a vending machine dispensing cycle is initiated.

According to the '774 application, a user interface may include a depressable or touch-sensitive keypad and a video monitor 61 operated by a processor with suitable drivers and/or other software. In an embodiment, the video monitor displays purchase options prompting the user to make one or more selections, and transmits command signals to the processor based on the purchaser's input selection indicating the specific type of product desired to be purchased and the amount of product desired to be purchased from each vender module.

According to the '774 application, in some embodiments the display monitor may provide an “attract” mode to attract purchasers to the vending machine. The processor may be provided with software for playing a video game via the display, with suitable interfaces for the purchaser such as a joystick, motion sensors, or the like.

United States Patent Application Publication No. 2017/0323510 to Rendell et al., the contents of which are incorporated herein by reference, discloses a vending machine wherein a variety of products are available for purchase, one or more of which may be dispensed during a vending operation into a single container, such as a bag.

According to the '510 application, in an embodiment a user interface comprises a mechanical keypad or touch-sensitive keypad (for example a touchscreen), and a video monitor 11 operated by a processor with suitable drivers and/or other software. In an embodiment the video monitor displays purchase options prompting the user to make one or more selections, and transmits command signals to a processor based on the purchaser's input selection indicating the specific type of product desired to be purchased and the amount of product desired to be purchased from each vender module. In an embodiment, a camera is mounted for capturing images of the purchaser.

A photograph of the purchaser may be taken during the product selection process by a camera, for use by a printing apparatus for print a picture on the bag, for example. It will be appreciated that authorization to capture photographs would be subject to permission given and/or local regulations.

The video monitor may also be used to display targeted advertising. For example, the camera captures images in the vicinity of the vending machine, including images of a purchaser and other individuals standing within the field of view of the camera. These images can be processed by available software loaded into the on-board or a remote server to determine the approximate age and gender of the purchaser, and of other individuals in the vicinity of the vending machine. The server can then select one or more stored advertisements and output a video signal to the video monitor which then displays advertising directed to the specific demographic represented by one or more individuals captured by the camera, based on the data regarding age, gender and potentially other factors that can be discerned from the individual's appearance (e.g. figure or physique, clothing style etc.). For example, advertising categorized by demographic may be stored in the on-board computer, and/or downloaded from the central server located at the head office of the vending machine operator, and can be changed in real-time as new individuals' images are captured by the camera. In some embodiments a separate display is mounted elsewhere on the housing, for example on the back of the housing, with an associated camera capturing a field of view within the viewing area of the display. The display(s) can default to an attract mode when no movement is detected around the camera(s) on the vending machine, and can switch to targeted advertising when an individual's image is detected within the field of view of the camera(s).

United States Patent Application Publication No. 2015/0314898 to Schwarzli et al. discloses that a vending kiosk may provide a an interactive touch display screen with associated audio, enabling the user to be instructed on available options and/or the process for purchasing merchandise from the kiosk, serving as a control panel for instructing the processor to drive the shuttle of the vending kiosk so as to align itself with vending modules for dispensing product.

BMC Universal Technologies Inc. of Newmarket, Ontario, Canada offers a BMC Media-Kiosk—an interactive, promotional kiosk that captivates potential customers' attention, gathers onsite consumer research, and delivers a brand experience. The kiosk dispenses products of various types and combinations, but also is capable of generating and providing consumer and customer-based marketing analysis data, a digital advertising platform, custom branding via a touchscreen user interface, and the like. With the BMC Media-Kiosk, brand owners can provide a vending experience integrated with exposure to brands through its display screens, speakers, smartphone engagement, microphones and the like, in order to provide a memorable customer experience in association with brands, even if the customer does not purchase a product from the vending machine during the time of the engagement. The BMC Media-Kiosk interacts with a customer via the touchscreen using PC-based custom software implemented in Adobe Flash AS3 and other software to capture and save transaction/order information entered by, or at least selected by, a customer via the touchscreen into a MySQL database. A middleware layer, in this embodiment written in Visual Basic (VB), queries the MySQL database for new or unprocessed transaction records, and generates and deploys instructions for the physical vending components of the vending machine to execute and complete a vending process corresponding to the new or unprocessed transaction records, thereby to dispense products according to the order made by the customer.

While the BMC Media-Kiosk provides significantly useful interactive and memorable customer engagements, whether or not a customer purchases an item for vending during the engagement, improvements in customer interfaces and the operation that enhancing customer engagement with a brand are always desirable.

### SUMMARY OF THE INVENTION

According to an aspect of the invention, there is provided a vending machine comprising: a secure housing; at least one dispensing element within the secure housing, each of the at least one dispensing element physically retaining at least one respective item within the secure housing and controllable during a dispensing operation to physically release at least one of the at least one item from within the vending machine to a person; and a character-based user interface associated with the secure housing, the character-based user interface comprising: an output system for presenting at least one stored video and/or audio sequence featuring a character; and an input system for receiving at least information provided by a person, the input system coordinated by the vending machine with the output system to receive at least some of the information in response to the presenting by the output system of a respective at least one video and/or audio sequence as a prompt for the person to provide the information.

In an embodiment, the vending machine further comprises: a transaction system responsive to the input system to determine whether a transaction condition has been satisfied by at least the information provided by the person and to, in the event the transaction condition has been satisfied: automatically generate an electronic transaction; and automatically initiate the dispensing operation in accordance with the electronic transaction.

In an embodiment, the transaction condition comprises receipt of at least valid payment information.

In an embodiment, the transaction condition further comprises receipt of information about a selection of at least one item to be dispensed.

In an embodiment, the transaction condition further comprises receipt of information validating the person as being authorized to obtain the at least one item.

In an embodiment, the input system comprises: an audio input system for capturing audio information of or provided by the person; and an image input system for capturing images and/or video of or provided by the person.

In an embodiment, the input system further comprises: a touch-based interface for capturing information provided by the person.

In an embodiment, the input system further comprises: a payment system for receiving and processing payment from the person.

In an embodiment, in an attract mode of the vending machine the input system is configured to receive information about a prospective customer prior to the prospective customer deliberately providing information to the input system, the output system being caused in response to the information received about the prospective customer to present at least one video and/or audio sequence as a prompt for the prospective customer to thereafter deliberately engage with the vending machine.

In an embodiment, the vending machine is configured to transition from the attract mode to a transaction mode in response at least determining that the prospective customer has deliberately engaged with the vending machine; wherein in the transaction mode of the vending machine the output system is caused to present at least one video and/or audio sequence as a prompt for the prospective customer to provide at least transaction information to the input system.

In an embodiment, in the transaction mode of the vending machine the input system additionally receives information from the prospective customer to select one or more items for dispensing.

In an embodiment, the vending machine is configured to transition from the transaction mode to a dispensing mode; wherein in the vending mode of the vending machine the output system is caused to present at least one video and/or audio sequence presented only while the vending machine is in the dispensing mode.

In accordance with another aspect, there is provided a use of a character-based user interface in a vending machine for interacting with a person to receive information from or about the person and to present at least one audio and/or video sequence of a character in response to the received information.

In an embodiment, the use comprises using the character-based user interface to receive information from the person to generate an electronic transaction and initiate a dispensing operation based on the electronic transaction.

In an embodiment, the use comprises using the character-based user interface to receive information from one or more people and from the other components of the vending machine, wherein the character-based user interface is configured to present to the one or more people based on the information from the one or more people and based on the information from the other components of the vending machine.

In an embodiment, the character-based user interface has “attract”, “transaction”, and “dispensing” modes, each causing the character-based user interface to present different respective audio/video sequences of the character to a person thereby to engage the person in different ways based on the modes, the use comprising using the modes of the character-based user interface to operate the vending machine in corresponding modes.

In an embodiment, the character is an animated character.

In an embodiment, video and/or audio sequences are stored.

In an embodiment, the video and/or audio sequences are generated in response to received information or vending machine information.

According to another aspect, there is provided a vending machine comprising a character-based user interface for interacting with a person to receive information from or about the person and to present at least one audio and/or video sequence of a character in response to the received information.

In an embodiment, the character-based user interface receives information from the person to generate an electronic transaction and initiate a dispensing operation based on the electronic transaction.

In an embodiment, the character-based user interface is configured to receive information from one or more people and from other components of the vending machine thereby to condition the character-based user interface to present to the one or more people based on the information from the one or more people and based on the information from the other components of the vending machine.

In an embodiment, the character-based user interface has “attract”, “transaction”, and “dispensing” modes, each causing the character-based user interface to present different respective audio/video sequences of the character to a person thereby to engage the person in different ways based on the modes, wherein the vending machine operates in corresponding modes.

In an embodiment, the character is an animated character.

In an embodiment, video and/or audio sequences are stored.

In an embodiment, the video and/or audio sequences are generated in response to received information or vending machine information.

According to another aspect, there is provided a character-based user interface for a vending machine, the character-based user interface configured to interact with a person to receive information from or about the person and to present at least one audio and/or video sequence of a character in response to the received information.

In an embodiment, the character-based user interface receives information from the person to generate an electronic transaction and initiate a dispensing operation based on the electronic transaction

In an embodiment, the character-based user interface is configured to receive information from one or more people and from other components of the vending machine thereby to condition the character-based user interface to present to the one or more people based on the information from the one or more people and based on the information from the other components of the vending machine.

In an embodiment, the character-based user interface has “attract”, “transaction”, and “dispensing” modes, each causing the character-based user interface to present different respective audio/video sequences of the character to a person thereby to engage the person in different ways based on the modes, wherein the vending machine operates in corresponding modes.

In an embodiment, the character is an animated character.

In an embodiment, the video and/or audio sequences are stored.

In an embodiment, the video and/or audio sequences are generated in response to received information or vending machine information.

In accordance with another aspect, there is provided a non-transitory computer readable medium embodying a computer program executable on a computing system for providing a character-based user interface for a vending machine, the computer program comprising: computer program code for interacting with a person to receive information from or about the person; and computer program code for presenting at least one audio and/or video sequence of a character in response to the received information.

In an embodiment, the computer program further comprises computer program code for causing the character-based user interface to interact with the person to generate an electronic transaction; and computer program code for initiating a dispensing operation based on the electronic transaction.

In an embodiment, the computer program further comprises computer program code for receiving information from one or more people and from the other components of the vending machine; and computer program code for conditioning the character-based user interface to present to the one or more people based on the information from the one or more people and based on the information from the other components of the vending machine.

In an embodiment, the character-based user interface has “attract”, “transaction”, and “dispensing” modes, each causing the character-based user interface to present different respective audio/video sequences of the character to a person thereby to engage the person in different ways based on the modes, wherein the vending machine operates in corresponding modes.

In an embodiment, the character is an animated character.

In an embodiment, the video and/or audio sequences are stored.

In an embodiment, the video and/or audio sequences are generated in response to received information or vending machine information.

According to another aspect, there is provided a method of operating a vending machine comprising: presenting at least one stored video and/or audio sequence featuring a character; and receiving at least information provided by a person, the receiving coordinated with the presenting to receive at least some of the information in response to the presenting by the output system of a respective at least one video and/or audio sequence as a prompt for the person to provide the information.

In an embodiment, the method further comprises: responsive to the receiving, determining whether a transaction condition has been satisfied by at least the information provided by the person and, in the event the transaction condition has been satisfied: automatically generating an electronic transaction; and automatically initiating a dispensing operation in accordance with the electronic transaction.

In an embodiment, the transaction condition comprises receipt of at least valid payment information.

In an embodiment, the transaction condition further comprises receipt of information about a selection of at least one item to be dispensed.

In an embodiment, the transaction condition further comprises receipt of information validating the person as being authorized to obtain the at least one item.

In an embodiment, the receiving comprises: capturing audio information of the person; and capturing images and/or video of the person.

In an embodiment, the receiving further comprises: capturing information provided by the person via a touch-based interface of the vending machine.

In an embodiment, the receiving further comprises: receiving payment from the person via a payment system of the vending machine.

In an embodiment, the method further comprises: storing each of the at least one stored video and/or audio sequence featuring a character in association with a respective one of “attract”, “transaction”, and “dispensing” modes of the vending machine; and presenting the at least one stored video and/or audio sequence in accordance with in which of the modes the vending machine is operating.

In an embodiment, the method further comprises: in an attract mode of the vending machine: receiving information about a prospective customer prior to the prospective customer deliberately providing information to the input system; and in response to the information received about the prospective customer, presenting at least one video and/or audio sequence as a prompt for the prospective customer to thereafter deliberately engage with the vending machine.

In an embodiment, the method further comprises: transitioning from the attract mode to a transaction mode in response at least determining that the prospective customer has deliberately engaged with the vending machine; in the transaction mode, presenting at least one video and/or audio sequence as a prompt for the prospective customer to provide at least payment information to the input system.

In an embodiment, the method further comprises: in the transaction mode, receiving information from the prospective customer to select one or more items for dispensing.

In an embodiment, the method further comprises: transitioning from the transaction mode to a dispensing mode; in the dispensing mode, presenting at least one video and/or audio sequence to be presented only while the vending machine is in the dispensing mode.

Other aspects and embodiments will be apparent within the description and drawings.

### BRIEF DESCRIPTION OF THE DRAWINGS

Embodiments of the invention will now be described with reference to the appended drawings in which:

FIG. 1 is a perspective view of a BMC Media-Kiosk vending machine with a character-based user interface depicting an animated character displayed on a display screen of the vending machine;

FIG. 2 is a perspective view of the BMC Media-Kiosk vending machine of FIG. 1, with the animated character in a different position being displayed on the display screen of the vending machine;

FIG. 3 is a schematic diagram of components of a vending machine such as the BMC Media-Kiosk of FIG. 1, including a character-based user interface interfacing with a middleware software layer, a payment module, a transaction records database, and physical vending components, according to an embodiment;

FIG. 4 is a schematic diagram of components of a vending machine such as the BMC Media-Kiosk of FIG. 1, including a character-based user interface interfacing in a different way with the other vending machine components, according to an alternative embodiment; and

FIG. 5 is a schematic diagram of components of a computing system for implementing the character-based user interface within a vending machine such as the BMC Media-Kiosk of FIG. 1.

### DETAILED DESCRIPTION

In this description, “transaction” refers to the satisfaction of a necessary condition for dispensing an item and causing the dispensing of the item in response. A sale, in this description, is an example of a transaction during which payment of currency or other monetary-like consideration has been provided so that an item can be dispensed. In this description, a customer may transact by using loyalty points to satisfy the necessary condition. Other ways of satisfying a necessary condition for a transaction may be the providing of sufficient information, or the correct answer to a question. For example, in the context of vending machines, a transaction may be completed if a person responds to a vending machine with a correct answer and the vending machine, in response, dispenses an item.

In this description, a vending machine refers to a machine that houses one or more items that can be released to a person in response to a transaction. In this description, therefore, the terms vending and dispensing and releasing are generally used interchangeably within various contexts to refer either to a machine that can release one or more items to a person as part of a transaction or to the process of releasing an item by a machine to a person as part of a transaction.

In this description, a customer or prospective customer is a person who is, or can potentially, engage in a transaction with a vending machine. Other interactions with a vending machine that are not inherently transactional, including those that could lead to a transactional interaction and those that will not lead to a transactional interaction, are described herein.

According to embodiments, a character-based user interface for engaging, interacting with, and entertaining people, customers, prospective customers, and/or for guiding people once engaged through ordering, vending, and post-vending experiences, is incorporated into a vending machine. In embodiments, the character-based user interface is a two-way graphical user interface employing audio and video playback and capture, to enable interaction between a character and a person or people. In an embodiment, the character-based user interface presents audio and/or video sequences of an animated character such as a fictional brand character associated with one or more products to be vended from the vending machine. This may be done in a manner similar to the appearance of the animated character on television or Internet advertisements, thereby injecting interactivity into the animated character at a potential point of sale.

A vending machine into which a character-based user interface is incorporated or with which the character-based user interface is associated may take the form of a BMC Media-Kiosk, a vending kiosk as disclosed in any of the '774 application, the '510 application, or the '898 application, or some other vending machine. Various vending machines include a pop can/bottle machine, a coil-based chip/candy machine, a hot drinks dispensing machine, or any other machine having a secure housing that contains products to be dispensed. Such machines generally include at least one dispensing element such as coils, bulk product canisters, ribbon vender modules, drink container elements, conveyor belts, and the like within the secure housing. Each dispensing element can physically retain one or more items of merchandise (food, drinks, toys, electronics, books etc.) within the secure housing and is controllable for a vending operation to physically release one or more of the items of merchandise to a customer. Such controlling may be electromechanically manipulating the dispensing element to transition from retaining an item of merchandise to releasing it.

It is preferred that the vending machine be of a form factor and design that can be integrated with an output system for presenting a character-based user interface using a computer display device, and with an input system include input devices and subsystems that can capture information about a person or people. Such input systems include video camera systems, microphones, proximity sensors, short-range wireless transceivers, and other mechanisms. The information can be processed by the vending machine for meaning, and can thereby inform how a character presented by the character-based user interface should behave (i.e., which audio and/or video sequences should be presented) in order to engage and interact with the person or people, and can be used to recognize product selections and to generate electronic transactions with prospective and actual customers. Such electronic transactions can be automatically generated by a transaction system responsive to the information received via the input system indicating a transaction condition has been satisfied. The dispensing operation itself can proceed in accordance with the electronic transaction. For example, this may be done once the generated electronic transaction has been successfully completed. In some embodiments, the transaction condition can be satisfied simply upon provision by the customer of sufficient payment using a card reader, coins, bills, wireless payment, or the like. This may be sufficient for embodiments of vending machines that contain and vend only one product. In other embodiments, the transaction condition is satisfied once the customer has provided information sufficient for identifying the item(s) to be vended in addition to the valid payment information. In other embodiments, where the products housed within the secure housing may only be vended to authorized customers, a customer may be required to provide information validating the customer as authorized. For example, for products requiring that the customer be at least a threshold age or be otherwise qualified to receive the product, the customer may be required to provide evidence of government-issued ID.

The input system may further include more traditional interfaces such as touch-based interfaces.

The output system of the character-based user interface may feature one or more display components working in conjunction with one or more input components of the input system, thereby to coordinate operations to provide the person's inputs with context. For example, one or more display screens and speakers may output various video and audio sequences featuring an engaging animated character. Presentation of such sequences may be done in response to input components such as a camera system and a microphone system capturing and processing information about the environment surrounding the vending kiosk, such as information about an individual person located near to, passing by, or approaching the media kiosk. The engaging animated character presented by and manipulated using the character-based user interface may present visually and audibly as a well-known brand character, such as the Mars™ M&Ms character “Red” featured in various television and online advertisements promoting M&Ms. One or more of multiple animated characters may be presented. For example, it may in some embodiments be appropriate to present a female animated character in response to the character-based user interface having detected, using the camera system, the presence of a female person nearby. Alternatively, it may be appropriate to present a child animated character in response to the character-based user interface having detected the presence of a child nearby. The animated character may present as an engaging character not particularly associated with a particular product brand or product contained within the vending machine.

The various video and audio sequences may be pre-recorded and stored local to, or remote from, the vending kiosk. In such a case, character logic of the character-based user interface, under certain conditions detected by the character-based user interface, selects and plays-back particular video and audio sequences on conjunction with one another thereby to animate the character. Such certain conditions may be based on the environmental conditions local to the vending kiosk. Such conditions may include the presence or absence of a proximate person, sounds in the vicinity of the vending kiosk, whether announcements in the location (such as an airport) are currently being made that should not be interrupted, the time of day, any information known about or offered by the person, and other conditions.

In another embodiment, the video and audio sequences may be wholly or partly generated for display in real-time. This may be done in response to environmental conditions such as detection of particular features or behaviours of a potential customer and particular predetermined constraints on how the character could act and speak. Such constraints could include constraints on physical flexibility of an animated character, physics of movement more generally, and the like.

In embodiments, the character-based user interface of the vending machine is capable of being in an “attract” mode, in a “transaction” mode, and in a “dispensing” mode. In embodiments, the character-based user interface is also capable of being in various “transition” modes, in order to transition to and from the “attract”, “transaction” and “dispensing” modes. Other modes are possible.

In “attract” mode, various video and audio sequences and behaviours of the character may be invoked or generated for the purpose of bringing a person physically closer, to initiate an engagement. For example, a particular video and audio sequence may be played back in response to the character-based user interface, using in particular its camera and/or microphone systems (or another system useful for detecting proximity of a potential customer) having detected a person who is not yet engaged. The vending machine receives information about the person that is not necessarily being provided by the person deliberately, in order to use that information to present an appropriate video and/or audio sequence to cause the person to engage. Such a particular video and audio sequence may feature the character facing in the direction the character-based user interface has detected the presence of the person and/or calling and/or gesturing with a wave thereby to calling the person closer.

In “attract” mode, the person may be engaged. The person may not be engaging for the purpose of beginning a transaction, but for information gathering and/or entertainment. As such, in the event the character-based user interface has been successful with calling the person closer to the vending machine (as detected by the camera and/or microphone systems or other proximity detector), the character-based user interface is then—because the person is closer—able to detect, with additional granularity, more about the person. The character-based user interface can then, based on the more granular information, trigger playback or generation of an appropriate different video and audio sequence to further the interaction. For example, at this stage, the character-based user interface could, having been successful with calling the person closer and as a result having been able to detect that the person presents as a man, play back or generate the corresponding audio and video sequence that causes the character to say “How are you buddy?” or, if a young female, could say “How are you, young lady?”. Then, the character-based user interface could—depending on the response to this query—play back other audio and video sequences to engage the person. For example, if the system accidentally detected that a young male was a young female, and the young male responded with “I am not a lady”, the system could play back or generate an audio and/or video sequence that causes the character to utter “Of course; I was talking to someone I saw behind you.” or some similar corrective response.

It will be appreciated that the way the character-based user interface operates in attract mode (and in other modes) should take into account modern norms for communications. For example, in certain societies, it may not be useful or productive when attempting to make sales to assume a person's gender without first asking the person how they would like to be addressed. In attract mode, the goal is to bring a person near, to generally make the person feel comfortable and/or interested, and to (if possible) give the person every reason to be pleased about proceeding with the interaction and also quite willing to let other people know about the system. As such, particular prompts and assumptions that could be off-putting, impolite, or politically incorrect should be avoided. It will be appreciated that such norms change over time. As such, a character's behaviour should be modifiable over time, or with the character's appearance itself, so that system integration personnel responsible for the vending machine will have the flexibility to update the character's interacting ability to represent the brand as politely, compellingly and appropriately as the brand would like to be represented at that time.

During a “transition” mode, the character-based user interface would be transitioning from “attract” mode to “transaction” mode, from “transaction” mode to “dispensing” mode, from “dispensing” mode back to “attract” or “transaction” mode, or the like. Where a “transition” mode between “attract” and “transaction” modes is concerned, particular video and audio sequences that inform the now-engaged person (who is, at this point, a prospective customer) that the character-based user interface is preparing to accept information from the person about an actual order may be selected/generated and played back. This transition mode may be invoked in response to a potential customer speaking a particular phrase (“May I order something?”) or may be invoked in response to the character-based user interface having detected using its camera system and/or its microphone system that there is a line forming behind the engaged person and that the “attract” mode should therefore be quickly transitioned-from, or in response to a particular “attract” script having come towards a close. During the transition mode, particular video or audio sequences may be selected/generated and played back depicting the character transitioning, to provide a person with visual and audible feedback indicating the interaction is moving towards a “transaction” mode. For example, the visual and audible feedback may include playing back a video sequence depicting the character putting on a chef's hat and a corresponding audio sequence with the character saying “Okay, I'm having fun, and so I'd love to take your order now if you're ready. Would you like to know your options?” At this stage, in response to the person nodding and/or speaking the word “Yes” (as detected by a camera system and/or microphone) the character-based user interface would enter into “transaction” mode.

Alternatively, during the transition mode, a person may be provided with the opportunity to reverse from the transition mode and back into attract mode, depending on the environment, how the vending kiosk providers with for the system to operate, and what the person wishes to do. For example, in the event that the character-based user interface enters transition mode, the person may utter “Wait” and the character-based user interface may play back a particular video and audio sequence corresponding to “Oh, sure! Not ready to order yet?” or some such output.

An additional, different, transition mode may be entered into upon completion of a transaction mode, where the vending machine is to enter into a dispensing mode, and after the vending machine has completed its dispensing mode, and so forth.

In “transaction” mode, the character-based user interface guides the person through the process of selecting which of the products the person would like to buy and have vended by the vending kiosk. In an embodiment, a person is unable to exit from transaction mode without also cancelling the order, thereby returning the character-based user interface to “attract” mode or some other mode appropriate for playing back video and audio sequences corresponding to wishing the customer farewell in a brand-friendly, memorable way.

During transaction mode, the character-based user interface is guiding the person through steps in order to complete an order. In embodiments in which the vending machine camera is equipped to capture a photograph of the person for printing on a bag, the character-based user interface can guide the person to a particular physical position in front of the camera to be centred, and can even provide the person with the option of including the character itself in the photograph, perhaps with the character's arm around the shoulder of the person, for printing on the bag. In particular, the character-based user interface is presenting available options and confirming when the person has selected an option. In embodiments in which the character-based user interface uses a touch screen interface for receiving the person's selection, with perhaps some guidance from an animated character, the person's wishes are likely to be unambiguous. However, in embodiments in which the person is asked to gesture or speak in order to enter the orders, the character-based user interface may be required to execute disambiguation routines so that an underlying middleware layer can, with certainty, execute on an order by causing the payment module and the vending machine components to operate in accordance with the person's expectations.

A disambiguation routine in the character-based user interface is useful when the character-based user interface is to be in communication with components of the vending machine that are not themselves equipped to adapt to ambiguous instructions. In this way, many components of the vending kiosk can be provided with information from various kinds of interfaces (such as the touch screen human-machine interface which potentially is less ambiguous due to the way in which selections are to be made—touch at particular spots on a screen, and the character-based user interface which is potentially more ambiguous due to the way in which selections are to be made—gesture or voice) without themselves having to be modified to handle ambiguities.

A character-based user interface may be equipped to recognize certain features, gestures, sounds/utterances, and the like detected using the camera system and/or the microphone system, by comparing captured video and/or audio to its training. The character-based user interface may be implemented using a particular configuration of computing system that has been configured using machine-learning, such as deep learning. With machine learning, a computing system is trained to recognize a gesture, feature and/or sound/utterance made in a particular instance of captured video and/or audio to which it has not been previously exposed. Such training may be supervised or unsupervised, and is the subject of much study. Generally-speaking, during such training, a computing device is provided with hundreds or thousands of instances of audio files or video or image files, each effectively labelled with one or more particular meanings, such as “face” or “frown” or “removing hat from head”. The computing system is configured to accept the pixel and/or audio data from several different instances and to “abstract” meaning from it for storage as a neural network or deep learning model. In this way, the computing system so-trained becomes increasingly adept, like humans, at associating the abstracted meaning with the label and can thus abstract meaning from a previously-unseen/unheard sample thereby to classify the sample and accordingly take an appropriate action based on it.

The training of a character-based user interface may include providing the computing device with hundreds or thousands of instances of video files of people pointing in slightly different directions with respect to the camera capturing the video files, so that the character-based interface can learn to discern whether a given person is intending to point at one thing or another. This may be incorporated into a vending machine to enable the machine to discern at which displayed product of many a person is pointing. As different products in a vending machine may be displayed physically very closely to each other, the training would account for the location of the person with respect to the machine, and the angles (incline or decline, left or right, for examples) at which the person's hand is outstretched, in order to correlate that recognition with a given product on display in the vending machine. In this way, product selection could be done by a person without their necessarily speaking, and without having to touch the vending machine at all.

A trained character-based user interface may capture gestures and utterances from a person or people, via the camera system and/or microphones, which it is not yet adept at classifying unambiguously—at first instance. For example, a particular person may feel she is nodding her head, and thus intends to instruct the character-based user interface with a “yes”, but the character-based user interface is only able to determine with 50% certainty that the video sequence captured of the person's action contains a “nod”. However, other downstream components/modules of the vending machine require to be instructed with more certainty than is provided—at first instance—by the character-based user interface, so that they may operate in a manner that is in accordance with what the person intends. As such, in the event that the first instance of assessing the intention of the person results in the character-based user interface having a confidence below a particular threshold as to the intent of the person, such as below 75% confidence, the character-based user interface may execute a disambiguation routine.

The disambiguation routine(s) operates to seek confirmation of a person's intention for an instruction for the vending machine where confidence in the person's instruction is below a certainty threshold, and may be conducted in various ways. For example, where the character-based user interface determines that it is not sufficiently certain of an initial “yes” instruction, the character-based user interface may play back or generate a particular audio and/or video sequence. Such a particular sequence would present as asking the same question again, or as asking the person who has made a initial gesture instruction to confirm their instruction by then speaking their instruction. In this way, the vending machine can confirm that the initial video sequence captured of the person contained a “nod” by detecting that the subsequent audio sequence captured of the person contains a spoken “yes”, for example. Other options are to present sequences to ask the person who has made a first gesture instruction to make another, different gesture in order to confirm their instruction (so as to confirm that the initial video sequence captured of the person contained a “nod” by detecting that the subsequent video sequence captured of the person contained a “jump up and down”, for example). Other options are to present sequences that ask the person who has made an initial verbal instruction to confirm their instruction by then speaking a second verbal instruction (so as to confirm that the initial audio sequence captured of the person contains a spoken “yes” by detecting that the subsequent audio sequence captured of the person contained a “you betcha”, for example). The disambiguation routine may alternatively, or in some combination, display selectable icon on a touch screen and request that the person physically touch the touch screen in accordance with their intended instruction (so as to confirm that the initial audio and/or video sequence contains a “yes” by detecting that the person touched a region of the touch screen corresponding to the “yes” icon, which serves also to unambiguously provide the instruction).

As will be understood, executing a disambiguation routine for increasing the confidence of person's intentions when conducting a transaction can also be useful for actually improving the training of the character-based user interface. This is because the process of obtaining less ambiguous instructions using another means of obtaining those same instructions serves, somewhat, to “label” the video and/or audio sequence containing the initial, originally-ambiguous, instructions. Such labelled audio/video sequence(s) could, under certain circumstances, be employed during subsequent training of the character-based user interface either just locally or both locally and remotely for use by other, similarly deployed, character-based user interfaces. Multiple deployments of vending machines, each containing a character-based user interface as described herein, could be made rapidly more capable by being so-“trained” individually while also carrying out their primary role as interacting with people and transacting with people for vending products. As certain jurisdictions set limits on storage and transmission of any personal information—such as video or audio captured of a person—the character-based user interface may conduct a local training process that captures that information for immediate engagement and transaction purposes, processes the information for training purposes, and then otherwise destroys the captured information or at least processes it to remove any information that could be used to personally-identify the person.

While embodiments may implement the disambiguation routine as part of the character-based user interface module, in other embodiments such a disambiguation routine may be implemented at or at least triggered by a middleware software layer of the vending machine.

Dispensing mode can involve several operations (shuttle movement, printing, vending module dispensing, bag sealing, dispensing of sealed bag, etc.). As such, in embodiments, the character-based user interface is able to, via an application programming interface (API), periodically query a middleware software layer to determine the dispensing status of the vending machine during the dispensing mode. Alternatively, the middleware software layer can automatically transmit the dispensing status to the character-based user interface. In this way, the character-based user interface can present video and/or audio sequences corresponding to respective different operations, thereby to continue to engage the person in interesting ways while the product vending operations are being carried out by the vending machine. For example, when the shuttle is carrying a bag to the printing station of the vending machine, the character-based user interface can present audio and video sequences explaining, “we are now printing nutritional information about your choices onto the bag so you can take that information with you!” Then, when the shuttle is conveying the bag towards a dispensing module containing M&M's, the character-based user interface can present audio and video sequences explaining that “Oh, the M&M's are being dispensed now! Yum!”, and so forth.

In this way, the character-based user interface is provided with inputs from both the person and the internal components of the vending machine, thus providing the character-based user interface with prompts and information that can further engage and inform the person throughout the entire duration of the experience. Such information can also include error information, providing the character-based user interface with the opportunity to present audio and/or video sequences that explain to the person that there is an error, and that may ask for patience or may engage the user in another appropriate way.

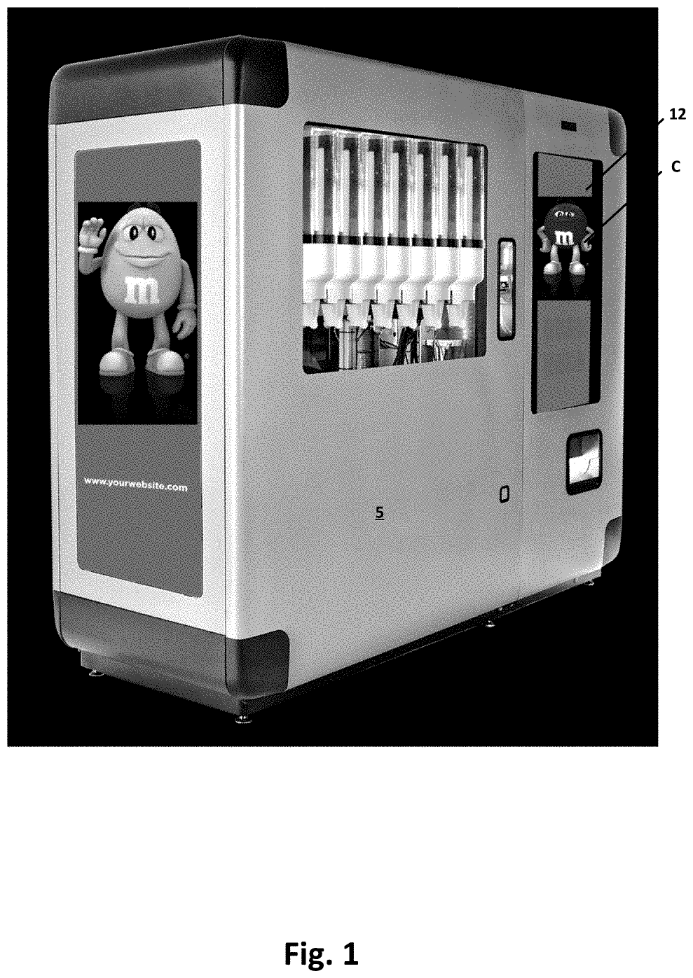

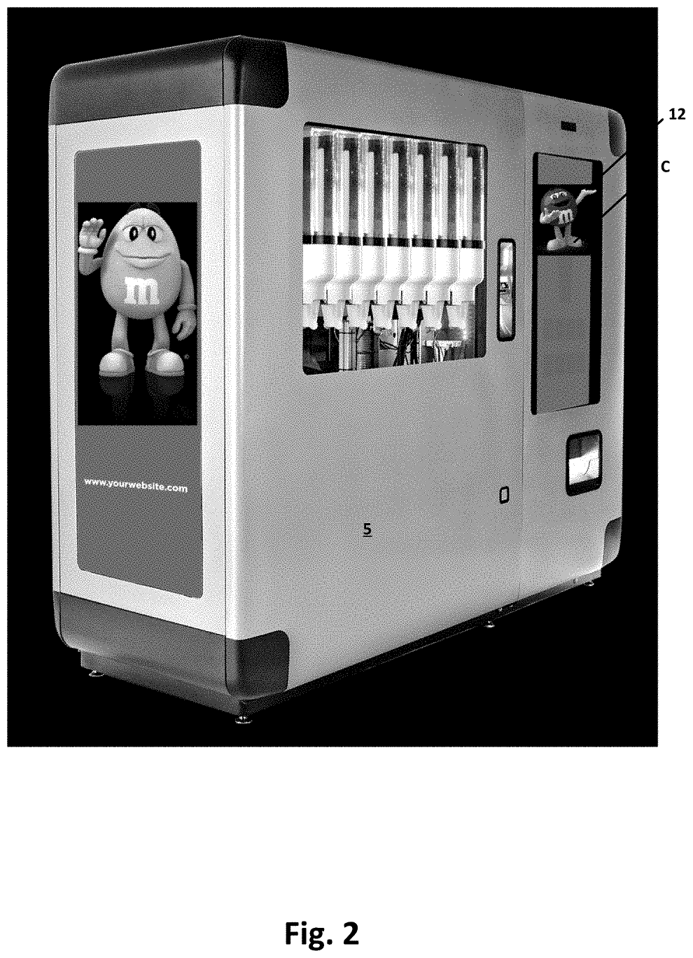

FIG. 1 is a perspective view of a BMC Media-Kiosk vending machine 5 with a character-based user interface 10 depicting an animated character C displayed on a display screen 12 of the vending machine 5, a camera system 20 having at least one video camera 22 with field of view corresponding to the vicinity of the vending machine 5, at least one speaker 14, and at least one microphone 24 having a listening range corresponding to the vicinity of the vending machine 5. FIG. 2 is a perspective view of the BMC Media-Kiosk vending machine 5, with the animated character C in a different position being displayed on the display screen 12 of the vending machine, thereby to illustrate simply, that the character C changes in position, orientation, and expression during animation.

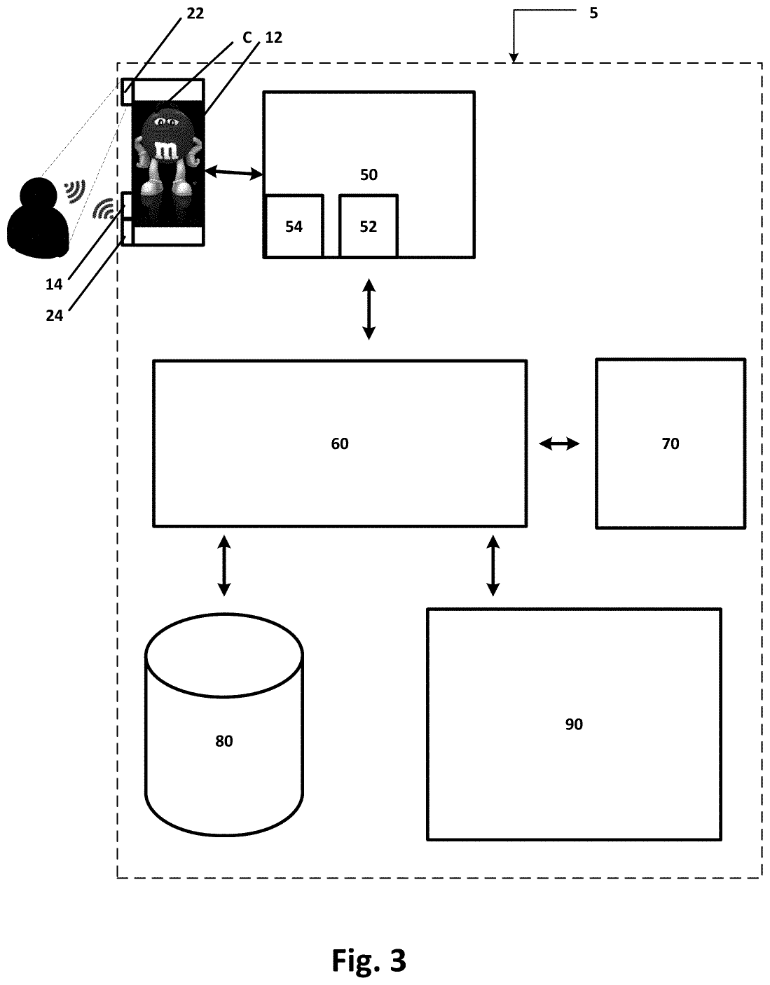

FIG. 3 is a schematic diagram of components of a vending machine 5 such as the BMC Media-Kiosk of FIG. 1, including a character-based user interface module 50 in communication with display screen 12 and interfacing with a middleware software layer 60, a payment module 70, a transaction records database 80, and physical vending components 90, according to an embodiment. In this embodiment, display screen 12 is sized and oriented to display a user interface to people. The display screen 12 depicts the animated character C. The behavior of character C—that is, the actions character C is depicted taking, the sounds character C is to make, the questions character C is to ask, and the state of the camera system 20 and microphone system 24 (listening, not listening) is controlled by character UI module 50, implemented in software. In this embodiment, character UI module 50 stores or has access to video and audio sequences that may be selected for display by a character logic module 52. Character logic module 52 selects from various outputs available in character UI module 50, such as a video and audio output selected from a library 54. Such a library 54 is, in this embodiment, stored locally or retrieved via network. The character logic module 52, simultaneously or in sequence, instructs character UI module 50 to put microphones 24 and camera system 20 into a “reception” state to receive either prompted or unprompted input from a person.

In this embodiment, character logic module 52 is in communication with the middleware software layer 60 of vending system. Middleware layer 60 is, in turn, in communication with payment module 70, transaction records database 80, and with controllers and sensors that make up the physical dispensing components 90. In this embodiment, middleware layer 60 provides an application programming interface (API) accessible by character logic module 52 for both receiving data from, and providing data to, character logic module 52. In this way, character logic module 52 and character UI module 50 can remain intact and usable without having to know the implementation details of payment module 70, transaction records database 80, or physical dispensing components 90, leaving such details, to a degree, to middleware layer 50. As such, different implementations of different dispensing systems, one including a character UI with no touch screen UI, one including a touch screen with no character UI, or one including some combination of the two or some other person interface components, can be provided, without modification of how payment module 70, transaction records database 80, and physical dispensing components 90 are respectively internally implemented.

In this embodiment, middleware layer 60 provides, via a REST (Representational State Transfer) API (Application Programming Interface), a set of functions that may be called by character logic module 50. In this embodiment, these functions include those shown in Table 1, below:

TABLE 1

| Function Name | Arguments | Description |
|---|---|---|
| Request_Nutrition_Constitutent | Item | In any mode, if the character |
| | | UI detects the person |
| | | requesting calorie, vitamin, |
| | | mineral, fat, carbohydrate, salt |
| | | content, this information can |
| | | be retrieved and displayed |
| | | prominently on display |
| | | screen. Individual functions |
| | | for each of these constituents |
| | | in isolation can be called, |
| | | rather than all of them |
| | | together, depending on how |
| | | implementers wish to make |
| | | this Function available. |
| Request_Nutrition_Risks | Item | In any mode, if the character |
| | | detects the person requesting |
| | | risk information such as nut |
| | | risk, allergen risk, and other |
| | | risks, this information can be |
| | | retrieved and displayed |
| | | prominently on display |
| | | screen. |
| Add item to order | Item | If there is no current open |
| | | order/transaction, then create |
| | | a new order/transaction and |
| | | add item (provided by |
| | | argument to the function, such |
| | | as via an itemID and a |
| | | corresponding quantity) to the |
| | | newly opened order/ |
| | | transaction. |
| | | If there is an existing open |
| | | order/transaction, then add the |
| | | item to the existing |
| | | order/transaction. |
| Remove item from order - | | Remove an item, previously |
| | | added to the current open |
| | | order/transaction, from the |
| | | open current order/transaction |
| | | (provided by argument to the |
| | | function, such as via an |
| | | itemID) |
| Cancel Order | | If there is a current |
| | | order/transaction, cancel the |
| | | current order/transaction and |
| | | prepare to start a new |
| | | order/transaction. |
| Get Total | | Return the current order total. |
| Pay Now - from Character UI to | | Instruct middleware layer 60 |
| BMC or BMC to Character UI - | | to finalize transaction record |
| order process complete (or bag is | | in database 80 and to invoke |
| full so forced to be complete), | | the payment module 70 to |
| allow for payment to be accepted | | collect payment according to |
| | | the totals in the finalized |
| | | transaction record. |
| Selected Bag | | Provide selection of bag size |
| | | to associate with current open |
| | | order/transaction. |
| Get Available Bag Sizes | | Return available bag sizes. |
| Get Available Products | | Return available products to |
| | | offer. |
| Check Status of Machine | | Return current vend status of |
| | | machine. |
| Trigger Error | | Send interrupt to character |
| | | logic module 50 in the event |
| | | of an error in the process, |
| | | including the vend process, |
| | | the payment process, etc. |
| Clear Error | | Inform character logic module |
| | | 52 of a clearance of a |
| | | previously reported error. |

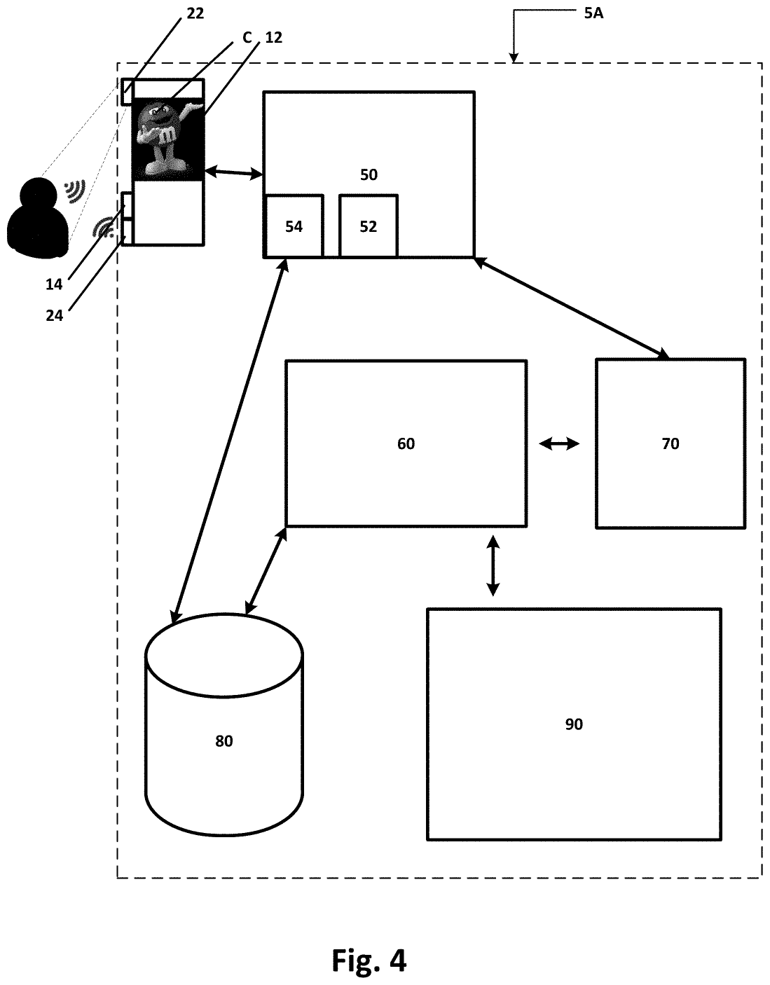

Another embodiment of a vending machine 5A is shown in FIG. 4. In this embodiment, character logic module 50 communicates directly with transaction records database 80, and payment module 70. In turn, the middleware layer 60—which may be adapted for use with touchscreen user interfaces and not specifically for character-based user interfaces of the type described herein—does not have to be modified to provide an API for access by character logic module 52, but interacts with the other components by, for example, taking orders, inserting the orders as records into transaction records database 80 which is then, in turn, queried by middleware layer 60 to observe a new transaction that middleware layer 60 can translate into actions for physical dispensing components 90 to provide the actual dispensing of products. With this architecture, a developer may create a character-based user interface using a character UI module 50 that is adapted to handle all logic for engaging a person and taking an order, and inserting a transaction into transaction records database 80. In this embodiment, the character-based user interface is less-integrated with the overall operation of vending machine 5A, since it is not provided with information about the state of the physical dispensing components 90, for example, but can be effective at initial person engagement and taking orders before handing-off subsequent operations to the other components of the vending machine 5A.

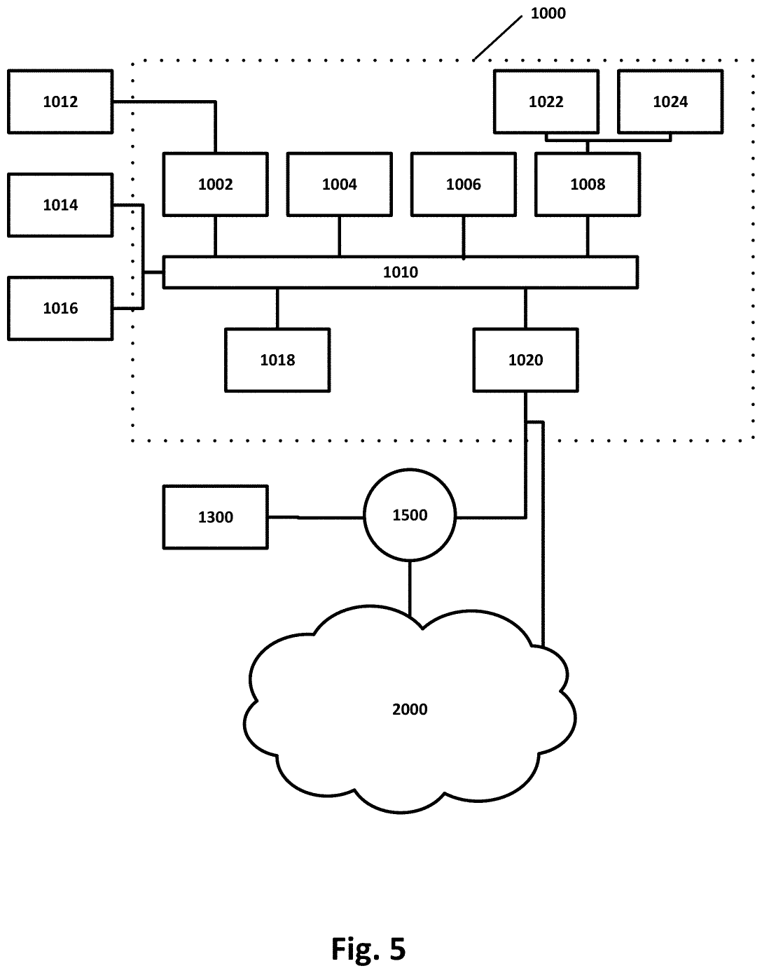

FIG. 5 is a schematic diagram showing a hardware architecture of a computing system 1000 suitable for supporting and implementing a character-based user interface such as that described herein, and other control and logic components of a vending machine 5 or 5A such as those described herein.

Computing system 1000 includes a bus 1010 or other communication mechanism for communicating information, and a processor 1018 coupled with the bus 1010 for processing the information. The computing system 1000 also includes a main memory 1004, such as a random access memory (RAM) or other dynamic storage device (e.g., dynamic RAM (DRAM), static RAM (SRAM), and synchronous DRAM (SDRAM)), coupled to the bus 1010 for storing information and instructions to be executed by processor 1018. In addition, the main memory 1004 may be used for storing temporary variables or other intermediate information during the execution of instructions by the processor 1018. Processor 1018 may include memory structures such as registers for storing such temporary variables or other intermediate information during execution of instructions. The computing system 1000 further includes a read only memory (ROM) 1006 or other static storage device (e.g., programmable ROM (PROM), erasable PROM (EPROM), and electrically erasable PROM (EEPROM)) coupled to the bus 1010 for storing static information and instructions for the processor 1018.

Computing system 1000 also includes a disk controller 1008 coupled to the bus 1010 to control one or more storage devices for storing information and instructions, such as a magnetic hard disk 1022 and/or a solid state drive (SSD) and/or a flash drive, and a removable media drive 1024 (e.g., solid state drive such as USB key or external hard drive, floppy disk drive, read-only compact disc drive, read/write compact disc drive, compact disc jukebox, tape drive, and removable magneto-optical drive). The storage devices may be added to the computing system 1000 using an appropriate device interface (e.g., Serial ATA (SATA), peripheral component interconnect (PCI), small computing system interface (SCSI), integrated device electronics (IDE), enhanced-IDE (E-IDE), direct memory access (DMA), ultra-DMA, as well as cloud-based device interfaces).

Computing system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

Computing system 1000 also includes a display controller 1002 coupled to the bus 1010 to control a display 1012, such as an LED (light emitting diode) screen, organic LED (OLED) screen, liquid crystal display (LCD) screen or some other device suitable for displaying information to a computer user. In embodiments, display controller 1002 incorporates a dedicated graphics processing unit (GPU) for processing mainly graphics-intensive or other highly-parallel operations. Such operations may include rendering by applying texturing, shading and the like to wireframe objects including polygons such as spheres and cubes thereby to relieve processor 1018 of having to undertake such intensive operations at the expense of overall performance of computing system 1000. The GPU may incorporate dedicated graphics memory for storing data generated during its operations, and includes a frame buffer RAM memory for storing processing results as bitmaps to be used to activate pixels of display 1012. The GPU may be instructed to undertake various operations by applications running on computing system 1000 using a graphics-directed application programming interface (API) such as OpenGL, Direct3D and the like.

Computing system 1000 includes input devices, such as a keyboard 1014 and a pointing device 1016, for interacting with a computer user and providing information to the processor 1018. The pointing device 1016, for example, may be a mouse, a trackball, or a pointing stick for communicating direction information and command selections to the processor 1018 and for controlling cursor movement on the display 1012. The computing system 1000 may employ a display device that is coupled with an input device, such as a touch screen. Other input devices may be employed, such as those that provide data to the computing system via wires or wirelessly, such as gesture detectors including infrared detectors, gyroscopes, accelerometers, radar/sonar, microphones and the like. A printer may provide printed listings of data stored and/or generated by the computing system 1000.

Computing system 1000 performs a portion or all of the processing steps discussed herein in response to the processor 1018 and/or GPU of display controller 1002 executing one or more sequences of one or more instructions contained in a memory, such as the main memory 1004. Such instructions may be read into the main memory 1004 from another processor readable medium, such as a hard disk 1022 or a removable media drive 1024. One or more processors in a multi-processing arrangement such as computing system 1000 having both a central processing unit and one or more graphics processing unit may also be employed to execute the sequences of instructions contained in main memory 1004 or in dedicated graphics memory of the GPU. In alternative embodiments, hardwired circuitry may be used in place of or in combination with software instructions.

As stated above, computing system 1000 includes at least one processor readable medium or memory for holding instructions programmed according to the teachings of the invention and for containing data structures, tables, records, or other data described herein. Examples of processor readable media are solid state devices (SSD), flash-based drives, compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of processor readable media, is software for controlling the computing system 1000, for driving a device or devices to perform the functions discussed herein, and for enabling computing system 1000 to interact with a human user (e.g., for controlling mixing of live-streams of audio and video and other media). Such software may include, but is not limited to, device drivers, operating systems, development tools, and applications software. Such processor readable media further includes the computer program product for performing all or a portion (if processing is distributed) of the processing performed discussed herein.

The computer code devices discussed herein may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

A processor readable medium providing instructions to a processor 1018 may take many forms, including but not limited to, non-volatile media, volatile media, and transmission media. Non-volatile media includes, for example, optical, magnetic disks, and magneto-optical disks, such as the hard disk 1022 or the removable media drive 1024. Volatile media includes dynamic memory, such as the main memory 1004. Transmission media includes coaxial cables, copper wire and fiber optics, including the wires that make up the bus 1010. Transmission media also may also take the form of acoustic or light waves, such as those generated during radio wave and infrared data communications using various communications protocols.

Various forms of processor readable media may be involved in carrying out one or more sequences of one or more instructions to processor 1018 for execution. For example, the instructions may initially be carried on a magnetic disk of a remote computer. The remote computer can load the instructions for implementing all or a portion of the present invention remotely into a dynamic memory and send the instructions over a wired or wireless connection using a modem. A modem local to the computing system 1000 may receive the data via wired Ethernet or wirelessly via Wi-Fi and place the data on the bus 1010. The bus 1010 carries the data to the main memory 1004, from which the processor 1018 retrieves and executes the instructions. The instructions received by the main memory 1004 may optionally be stored on storage device 1022 or 1024 either before or after execution by processor 1018.

Computing system 1000 also includes a communication interface 1020 coupled to the bus 1010. The communication interface 1020 provides a two-way data communication coupling to a network link that is connected to, for example, a local area network (LAN) 1500, or to another communications network 2000 such as the Internet. For example, the communication interface 1020 may be a network interface card to attach to any packet switched LAN. As another example, the communication interface 1020 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1020 sends and receives electrical, electromagnetic or optical signals that carry digital data streams representing various types of information.

The network link typically provides data communication through one or more networks to other data devices, including without limitation to enable the flow of electronic information. For example, the network link may provide a connection to another computer through a local network 1500 (e.g., a LAN) or through equipment operated by a service provider, which provides communication services through a communications network 2000. The local network 1500 and the communications network 2000 use, for example, electrical, electromagnetic, or optical signals that carry digital data streams, and the associated physical layer (e.g., CAT 5 cable, coaxial cable, optical fiber, etc.). The signals through the various networks and the signals on the network link and through the communication interface 1020, which carry the digital data to and from the computing system 1000, may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computing system 1000 can transmit and receive data, including program code, through the network(s) 1500 and 2000, the network link and the communication interface 1020. Moreover, the network link may provide a connection through a LAN 1500 to a mobile device 1300 such as a personal digital assistant (PDA) laptop computer, or cellular telephone.

Alternative configurations of computing system may be used to implement the systems and processes described herein.

Electronic data stores implemented in the database described herein may be one or more of a table, an array, a database, a structured data file, an XML file, or some other functional data store, such as hard disk 1022 or removable media 1024.

Payment module 70 is suitable for interfacing with user interface components that can accept payment methods and can process payments made in such ways by the person. For this, a given implementation of vending machine may be configured to receive payment in one or in various ways, such as by having the user insert the required amount of coinage into a coin slot, and/or a bill of a sufficient denomination into a bill accepter slot, and/or a card such as a credit card, debit card or gift card into the card reader slot, and/or a points card or pre-loaded value card into the card reader slot, and/or an RFID (Radio Frequence IDentification) reader in communication with a person's RFID-enabled bracelet into proximity with an RFID reader or similarly-implemented stored payment system that would be suitable for a resort, campus or retirement home dining plan or the like, and/or a mobile device equipped with a mobile payment functionality such as Apple Pay and Android Pay transmitted over NFC (Near-Field Communications), and/or cryptocurrency acceptance and processing based on cryptocurrencies such as Bitcoin. Various other payment options to ease the process of payment by the person may be deployed, which are controlled through payment module 70 along with external communications required to verify payments with external payment processing systems.

Although embodiments have been described with reference to the drawings, those of skill in the art will appreciate that variations and modifications may be made without departing from the spirit, scope and purpose of the invention.

For example, various activities undertaken by the character-based user interface may be more directed to emphasizing interaction, rather than dispensing specifically. For example, it may be entirely useful to a brand owner to have an animated brand character presented in a character-based user interface of a vending machine simply engaging people, to help the people remember the brand. As such, the character-based user interface is useful for enhancing the brand recognition even when actual products are not vended from the vending machine with which it is integrated.

While an application programming interface (API) has been described with various functions for enabling character-based user interface to interact with the middleware layer and thus, in turn, sharing information with and between various components of the vending machine, other forms of integration are possible.

Where permitted by law, the character-based user interface may authenticate a person based on camera detection of the user's face or other biometric aspects, thereby to authorize financial transactions, retrieve a user profile such as past orders, or otherwise assist or engage a user that has previously engaged either the same vending machine, or another vending machine having the same or similar capabilities, or another character-based user interface associated with some other product or service.

Where the products to be vended are more highly regulated, such as in the cases of alcohol, cigarettes, and cannabis products, the camera detection of a user's face may be used to confirm, in conjunction with government-issued ID card such as a valid driver's license or a passport being presented to the vending machine (via card reader or image sensor, for examples), that the person's detected face matches the face on the person's ID, that the ID is valid, and that the information in the ID indicates the person is authorized to have the chosen products dispensed to him or her. Embodiments may be possible in which the visual detection of the person can discern his or her age well enough to permit or deny dispensing, without having to also consult a government-issued ID for confirmation.

In embodiments, two vending machines occupying a physical area may be coordinated. For example, in the event that a middleware layer of one vending machine informs its character-based user interface that there is an error with the physical dispensing components, the character-based user interface may share that transaction with another vending machine in the vicinity (such as down the hall in an airport, for example), explain the error to the user, and asking the user to proceed to the other vending machine with some transaction identifier in order to have the products dispensed from the other machine. Various variations on this are possible, are directed to ensuring the person has a brand-positive experience, and is even delighted with the experience despite an initial setback.

In embodiments, a character-based user interface may include multiple display screens respectively positioned on a vending machine, so that more complex interactions with an animated character may be provided. For example, an animated character appearing on a display screen of a side of the vending machine may engage the user, call the user closer, and then guide the user around to the front of the vending machine where the animated character “meets” the user on the front-mounted display screen. Variations are possible.

In embodiments, the person may request to cease or not even begin interacting through talking and gestures with the character-based user interface and may instead request to interact with the vending machine using solely a touch screen or some other more traditional user interface elements such as physical buttons. This traditional touch-based interaction may be preferable for certain people, or for those people who are used to the vending machine and wish to immediately bypass the character interaction to just have a desired product paid for and vended.

A user interface element such as a button may be provided for going directly to product selection, or for more noticeably causing the character to stop its attempts at interaction in lieu of the person interacting with the more traditional interface(s). This interface-switching ability in the hands of the person can provide a person with different ways of interacting with the vending machine, that suit the person in terms of expediency, enjoyment, and ability. Where ability is concerned, it may be that a particular person is unable or at least less able to interact with the character using sound. A given person that is hearing impaired or has difficulty speaking the character's language should be able to communicate discretely to the vending machine that a verbal interaction is not preferred, and the machine upon detecting this can switch to offering an interaction that is more traditional such as touch screen and/or buttons and/or can activate closed captioning on the display(s).

While in embodiments described and depicted herein the character-based user interface is fully integrated with the vending machine itself, alternatives are possible. The character-based user interface may be referred to a person's mobile device, or presented on both the person's mobile device and the vending machine itself. For example, using wireless communication, a person's personal mobile device could be engaged to provide at least part of the character-based user interface on the person's display screen and using the mobile device microphone and touch capabilities. In such an embodiment, when a person's mobile device was brought near to a vending machine, the vending machine and mobile device could pair (using, for example, Bluetooth, WiFi Direct, or other form of Wireless Personal Area Network or Wireless Local Area Network technology) if authorized by the person. Upon pairing, the vending machine would query the mobile device for its capabilities and would thereafter instruct the mobile to device to present at least part of the character-based user interface. The vending machine might instruct the mobile device to present a companion user interface—either to present another character, or to present an ordering interface on the mobile device with which the user could interact to create an order.

Upon finalizing the order on the mobile device, and arranging payment, the vending machine would receive an instruction to vend the ordered product(s) from the mobile device. In this way, the person would interact primarily with their own mobile device directly but would be indirectly communicating with the vending machine. Equipping the mobile device with video and/or other capabilities may be done using a pre-loaded application on the mobile device. Such a pre-loaded application would be triggered to present the video by the vending machine using instructions sent over the communications link, may be transmitted in real-time by the vending machine itself, or may be caused to be transmitted to the mobile device from a remote location such as via a web-server. Which of these implementations is appropriate will depend on how great communications latency is expected to be, the capabilities of the mobile device itself, and the available bandwidth for transmitting and receiving information wirelessly.

While embodiments described and depicted herein involve a person engaging in a transaction with a vending machine, alternatives that employ the principles described herein are possible. For example, a person may interact with a character-based user interface of a vending machine to inquire about product information, or to be entertained, without proceeding to engage in a transaction with the vending machine. In embodiments, a vending machine may be configured to provide a character-based user interface that is not itself capable of engaging with a prospective customer in a transaction, but that is capable simply of interacting with a person to provide information and/or entertainment for the purpose of brand awareness or education. In such embodiments, if a transaction is to be conducted, it may be done using other user interface elements without the direct involvement of the character-based user interface.

1. A vending machine comprising:
a secure housing;
at least one dispensing element within the secure housing, each of the at least one dispensing element physically retaining at least one respective item within the secure housing and controllable during a dispensing operation to physically release at least one of the at least one item from within the vending machine to a person; and
a character-based user interface associated with the secure housing, the character-based user interface comprising:
an output system for presenting at least one stored video and/or audio sequence featuring a character; and
an input system for receiving at least information provided by a person, the input system coordinated by the vending machine with the output system to receive at least some of the information in response to the presenting by the output system of a respective at least one video and/or audio sequence as a prompt for the person to provide the information.

2. The vending machine of claim 1, further comprising:
a transaction system responsive to the input system to determine whether a transaction condition has been satisfied by at least the information provided by the person and to, in the event the transaction condition has been satisfied:
automatically generate an electronic transaction; and
automatically initiate the dispensing operation in accordance with the electronic transaction.

3. The vending machine of claim 2, wherein the transaction condition comprises receipt of at least valid payment information.

4. The vending machine of claim 3, wherein the transaction condition further comprises receipt of information about a selection of at least one item to be dispensed.

5. The vending machine of claim 3, wherein the transaction condition further comprises receipt of information validating the person as being authorized to obtain the at least one item.

6. The vending machine of claim 1, wherein the input system comprises:
an audio input system for capturing audio information of or provided by the person; and
an image input system for capturing images and/or video of or provided by the person.

7. The vending machine of claim 6, wherein the input system further comprises:
a touch-based interface for capturing information provided by the person.

8. The vending machine of claim 3, wherein the input system further comprises:
a payment system for receiving and processing payment from the person.

9. The vending machine of claim 1, wherein:
in an attract mode of the vending machine the input system is configured to receive information about a prospective customer prior to the prospective customer deliberately providing information to the input system, the output system being caused in response to the information received about the prospective customer to present at least one video and/or audio sequence as a prompt for the prospective customer to thereafter deliberately engage with the vending machine.

10. The vending machine of claim 9, wherein:
the vending machine is configured to transition from the attract mode to a transaction mode in response at least to determining that the prospective customer has deliberately engaged with the vending machine;
wherein in the transaction mode of the vending machine the output system is caused to present at least one video and/or audio sequence as a prompt for the prospective customer to provide at least transaction information to the input system.

11. The vending machine of claim 10, wherein:
in the transaction mode of the vending machine the input system additionally receives information from the prospective customer to select one or more items for dispensing.

12. The vending machine of claim 11, wherein:
the vending machine is configured to transition from the transaction mode to a dispensing mode;
wherein in the vending mode of the vending machine the output system is caused to present at least one video and/or audio sequence presented only while the vending machine is in the dispensing mode.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A method of operating a vending machine comprising:
presenting at least one stored video and/or audio sequence featuring a character; and
receiving at least information provided by a person, the receiving coordinated with the presenting to receive at least some of the information in response to the presenting by the output system of a respective at least one video and/or audio sequence as a prompt for the person to provide the information.

42. The method of claim 41, further comprising:
responsive to the receiving, determining whether a transaction condition has been satisfied by at least the information provided by the person and, in the event the transaction condition has been satisfied:
automatically generating an electronic transaction; and
automatically initiating a dispensing operation in accordance with the electronic transaction.

43. The method of claim 41, wherein the transaction condition comprises receipt of at least valid payment information.

44. The method of claim 42, wherein the transaction condition further comprises receipt of information about a selection of at least one item to be dispensed.

45. The method of claim 42, wherein the transaction condition further comprises receipt of information validating the person as being authorized to obtain the at least one item.

46. The method of claim 41, wherein the receiving comprises:
capturing audio information of the person; and
capturing images and/or video of the person.

47. The method of claim 46, wherein the receiving further comprises:
capturing information provided by the person via a touch-based interface of the vending machine.

48. The method of claim 46, wherein the receiving further comprises:
receiving payment from the person via a payment system of the vending machine.

49. The method of claim 41, further comprising:
storing each of the at least one stored video and/or audio sequence featuring a character in association with a respective one of “attract”, “transaction”, and “dispensing” modes of the vending machine; and
presenting the at least one stored video and/or audio sequence in accordance with in which of the modes the vending machine is operating.

50. The method of claim 41, further comprising:
in an attract mode of the vending machine:
receiving information about a prospective customer prior to the prospective customer deliberately providing information to the input system; and
in response to the information received about the prospective customer, presenting at least one video and/or audio sequence as a prompt for the prospective customer to thereafter deliberately engage with the vending machine.

51. The method of claim 41, further comprising:
transitioning from the attract mode to a transaction mode in response at least to determining that the prospective customer has deliberately engaged with the vending machine; and
in the transaction mode, presenting at least one video and/or audio sequence as a prompt for the prospective customer to provide at least payment information to the input system.

52. The method of claim 42, further comprising:
in the transaction mode, receiving information from the prospective customer to select one or more items for dispensing.

53. The method of claim 43, further comprising:
transitioning from the transaction mode to a dispensing mode; and
in the dispensing mode, presenting at least one video and/or audio sequence to be presented only while the vending machine is in the dispensing mode.
